(19) United States
(12) Patent Application Publication
(10) Pub. No.: US 2015/0353782 A1
(43) Pub. Date: Dec. 10, 2015

(54) STARCH BASED ADHESIVE COMPOSITION AND GLUE STICKS

(71) Applicant: 3M INNOVATIVE PROPERTIES COMPANY, Saint Paul,, MN (US)

(72) Inventors: Audrey FRICHOT, Magny-en-Vexin (FR); Isabelle N. DE SANTI, Le Pecq (FR)

(21) Appl. No.: 14/759,302

(22) PCT Filed: Jan. 10, 2014
(86) PCT No.: PCT/US2014/011024

§ 371 Date: Jul. 6, 2015

Related U.S. Application Data
(60) Provisional application No. 61/751,740, filed on Jan. 11, 2013.

(51) Int. Cl. C09J 103/02; C08K 5/098; C08K 5/053; C09J 105/00

(52) U.S. Cl. CPC C09J 103/02; C09J 105/00; C08K 5/098; C08K 5/053; C09J 2403/003; C09J 2405/003

(57) ABSTRACT

Adhesive compositions comprising at least one native starch; at least one gelling agent; sucrose; at least one humectant; and water. Also such compositions in the form of glue sticks.

### FIELD

The present invention relates to adhesive compositions and glue sticks.

### BACKGROUND

Glue sticks have long been produced for the bonding of paper and other substrates, offering relatively easy application and good adhesive properties on paper. Glue stick application typically involves stroking the surface of the stick against an adherent, then pressing the adherent against another surface or substrate to form a bond. In some cases the adhesive is applied to both adherent surfaces to increase adhesion. The adhesives suitable for glue sticks typically have sufficient integrity to be provided in stick form, yet smoothly dispense onto a substrate when gently glided over the substrate. Relevant performance characteristics for glue sticks include adhesive transfer to substrate, drying time, adhesion, slip, hardness, and appearance.

Glue sticks comprising a fatty acid salt offer smooth, even application and laudable adhesive properties on paper, as disclosed in U.S. Pat. No. 3,576,776 (Muszik et al.), U.S. Pat. No. 5,433,775 (Gardenier et al.), and U.S. Pat. No. 6,066,689 (Columbus et al.). This class of adhesives may be prepared by heating an appropriate blend of polymer(s), solvent(s), and fatty acid salt(s) until all components are dissolved, filling the material into desired containers, and cooling the product to room temperature. Typically, during cooling glue stick gelation occurs as the fatty acid salts phase separate from the adhesive solution and form crystals. Other known adhesive compositions suitable for use in glue sticks, such as those described in U.S. Pat. No. 7,915,338 (Hardy et al.) and US Publication No. 2009/0312472 (Hardy et al.), include a water soluble adhesive resin (e.g., polyvinylpyrrolidone), an alkanoate blend, polyhydric alcohol, and solvent(s). Known adhesive compositions suitable for glue sticks typically include at least one synthetic component.

The need exists for new adhesive compositions that provide or exceed desired performance and while comprising, and preferably consisting essentially of, renewable and sustainable raw materials.

### SUMMARY

The present invention provides starch based adhesive compositions and glue sticks comprising the same. The adhesive compositions and glue sticks of the invention comprise, and in some embodiments consist essentially of, renewable and sustainable raw materials. The adhesive compositions described herein, made with renewable and sustainable raw materials, have been surprisingly found to provide excellent adhesive performance and to be particularly well suited for glue sticks, providing a desirable setting time, adhesive transfer, appearance, and adhesion.

In one aspect, the present invention provides an adhesive composition comprising: a native starch; a gelling agent; sucrose; a humectant; and water.

In another aspect, the present invention provides an adhesive composition comprising:

(a) 10 to 30, preferably 15 to 25, wt % of at least one native starch;

(b) 15 to 30, preferably 20 to 25, wt % of sucrose;

(c) 5 to 15 wt % of at least one humectant, e.g., sobitol and glycerol;

(d) 0.5 to 10, preferably 3 to 8, wt % of at least one gelling agent, e.g., sodium stearate;

(e) 35 to 60 wt % of water;

and optionally up to 5 wt % of other additives.

In yet another aspect, an illustrative glue stick of the present invention comprises:

(a) 15 to 20 wt % of maize starch;

(b) 20 to 25 wt % of sucrose;

(c) 5 to 10 wt % of at least one humectant, e.g., sobitol and glycerol;

(d) 3 to 8 wt % of sodium stearate;

(e) 40 to 50 wt % of water;

and optionally up to 5 wt % of other additives.

Weight percent, percent by weight, % by weight, wt %, and the like are synonyms that refer to the concentration of a substance as the weight of that substance divided by the weight of the composition and multiplied by 100.

The terms “comprises” and variations thereof do not have a limiting meaning where these terms appear in the description and claims.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As recited herein, all numbers should be considered modified by the term “about”.

As used herein, “a,” “an,” “the,” “at least one,” and “one or more” are used interchangeably. Thus, for example, an adhesive composition comprising “a” humectant can be interpreted as an adhesive composition comprising “one or more” humectants.

Also herein, the recitations of numerical ranges by endpoints include all numbers subsumed within that range (e.g., 1 to 5 includes 1, 1.5, 2, 2.75, 3, 3.80, 4, 5, etc.).

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exhaustive list.

### BRIEF DESCRIPTION OF THE DRAWINGS

The invention is further explained with reference to the drawing wherein:

FIGS. 1a and 1b are depictions of aspects of the Adhesion Test according to the Examples described herein.

These figures are not to scale and are intended to be merely illustrative and not limiting.

### DETAILED DESCRIPTION OF ILLUSTRATIVE EMBODIMENTS

The naturally sourced adhesive compositions of the present invention comprise an adhesive resin, a humectant, a gelling agent, water, and optional additives to enhance performance or appearance. In preferred embodiments, adhesive compositions of the invention, and glue sticks made with same, contain 99% or more of naturally occurring renewable and sustainable materials.

Adhesive compositions of the present disclosure comprise a water soluble or water dispersible adhesive resin, which typically comprises a native starch and sucrose. As used herein, a native starch is a starch derived from a natural source and not a starch derivative. Native starches useful in the compositions of the present disclosure include any conventional tuber, cereal, or leguminous starch. Illustrative examples include pea starch, maize starch (including waxy maize starch), potato starch, amaranth starch, rice starch (including waxy rice starch), wheat starch (including waxy wheat starch), barley starch (including waxy barley starch), manihot starch, sago starch, and combinations thereof. In certain circumstances, the inclusion of a maize starch in the adhesive composition provides a desirable balance between appearance and adhesion. Exemplary maize starches include TACKIDEX® 250 and TACKIDEX® 036, both from Roquette America Inc., Keokuk, Iowa.

In some embodiments, the native starch accounts for at least 10 wt %, and in other embodiments at least 15 wt % of the adhesive composition. Typically, the starch accounts for no greater than 30 wt % and in other embodiments no greater than 25 wt % of the adhesive composition. Adhesive compositions comprising more than 30 wt % of starch may tend to be too viscous, while those comprising less than 15 wt % may only provide poor adhesion.

The adhesive compositions typically include at least 15 wt % sucrose and no greater than 30 wt % sucrose. Adhesive compositions comprising less than 15 wt % sucrose tend to create a weakened adhesive bond with an adherent (i.e., surface or substrate). Adhesive compositions comprising more than 30 wt % tends to disproportionately increase the setting time (i.e., the time necessary for the composition to dry on the surface of an adherent). In certain circumstances, the amount of sucrose in the composition is preferably at least 20 wt % and no greater than 26 wt %.

The adhesive compositions of the present disclosure typically include one or more gelling agents for forming the gel structure helpful in maintaining a glue stick. Suitable gelling agents are known and include salts of C₁₂₋₂₂ fatty acids of natural or synthetic origin, with those of natural origin presently preferred. In certain circumstances, sodium salts of C₁₄₋₁₈ fatty acids and mixtures thereof are preferred, particularly, sodium stearate. Other suitable gelling agents include polysaccharides gum, such as arabic gum, agar-agar, alginates, carageenan, peptine, xantham and gellan gums. The gelling agents are typically present in quantities of at least 0.5 wt % and no greater than 10 wt %, based on the weight of the composition. In certain implementations, it may be preferred that the gelling agent is present at a concentration of at least 3 wt % and no greater than 8 wt %.

Suitable humectants for use in the compositions include polyfunctional alcohols, such as propylene glycol, glycerol, polyglycerols, trimethylol propane, polyether glycols, sorbitol and/or low molecular weight starch hydrolyzates which have been converted into the corresponding polyols by reduction with hydrogen, and mixtures thereof. For example a mixture of glycerol and sorbitol may be used. The humectants mentioned should typically be used in quantities of at least 5 wt % and no greater than 15 wt % of the total composition. A particularly suitable total humectant concentration is 8 wt %.

It has been observed that although adhesive compositions comprising solely glycerol as humectant may exhibit other desired adhesive performance characteristics, they may tend to exhibit an undesireably long setting time of 4 minutes or more. Modifying the amount of glycerol in such a composition has limited if any effect on the setting time. However, if the composition is modified to include a combination of glycerol and sorbitol, the setting time can be dramatically reduced without negatively impacting the adhesive's other performance characteristics. Typically it is preferred that the composition comprise equal parts glycerol and sorbitol, i.e., the wt % ratio of glycerol to sorbitol is 1:1. In other embodiments, the ratio may be 2:1 or 3:1. Without wishing to be bound by theory, glycerol:sorbitol ratios above 4:1 may not exhibit appreciable impact on the setting time. By contrast, adhesive compositions including only sorbitol form brownish glue sticks due, perhaps, to excess caramelization of the starch and sucrose.

Achieving a permanent bond using an evaporating solution or gel is dependent on several factors, as is known to those of ordinary skill in the art. Further, a requirement specific to glue stick formulations is that at room temperature, the composition is a self-supporting solid capable of depositing an adhesive by rubbing on a substrate. The present compositions therefore are comprised of materials producing (1) a melting temperature above 105° F. (40° C.), (2) a relatively firm solid at room temperature, (3) a tacky coating immediately after stroking on a surface, (4) sufficient open time to achieve a bond, and (5) a viscoelastic solid upon drying.

Adhesive compositions of the present may include a variety of optional additives to improve appearance and/or performance. In many embodiments, the optional additives are such as are widely known in the art for improving the performance of glue sticks (see, e.g., U.S. Pat. Nos. 3,576,776, 5,433,775, or 6,066,689), and include plasticizers, fillers, tackifiers, pigments, biocides, defoamers, surfactants, dyes, fragrances and preservatives. These other additives may be added in minor amounts typically of less than about 5 wt % to improve performance, stability, microbial resistance, appearance, pH control and other attributes.

In some exemplary embodiments, an anti-foaming agent that reduces and/or hinders the formation of foam may be included in the adhesive composition. Suitable antifoaming agents are known in the art, and include, for example, silicone (co)polymers and/or poly(ethylene oxide)-poly(propylene oxide) copolymers. Illustrative examples of suitable antifoaming agents include polysiloxanes emulsions, e.g., Silcolapse® RG12 from Blue Star Silicones USA Corporation, East Brunswick, N.J., and AntiFoam B from Dow Corning Corporation, Midland, Mich.

The composition may also include certain biocides typically used in the industry to kill/inhibit bacteria, fungi or algae. Exemplary biocides include iodopropynyl butyl carbamate compounds such as 3-iodo-2-propynyl butylcarbamate (IPBC), as Preventol® MP100 from Lanxess Corporation, Pittsburgh, Pa.

It is envisioned that the adhesive compositions of the present disclosure may also contain minor amounts of dyestuffs as well as pigments and decorative materials. They may contain odor improving compounds such as pine-needle oil, eucalyptus oil, anise seed oil, benzaldehyde and the like.

If used, suitable surfactants can include anionic surfactants, cationic surfactants, zwitterionic surfactants, nonionic surfactants, and mixtures thereof.

The adhesive compositions can have any useful pH value, though presently preferred compositions are slightly basic. In many embodiments, the adhesive composition has a pH value in a range from 6 to 11, or 7 to 11, or 8 to 10.

In some embodiments, an adhesive composition of the invention comprises, and if desired may consist essentially of:

(a) 10 to 30, preferably 15 to 25, wt % of at least one native starch;

(b) 15 to 30, preferably 20 to 25, wt % of sucrose;

(c) 5 to 15 wt % of at least one humectant, e.g., a mixture of glycerol and sorbitol having a weight ratio of glycerol to sorbitol of from 1:1 to 4:1;

(d) 0.5 to 10, preferably 3 to 8, wt % of at least one gelling agent;

(e) 35 to 60 wt % of water; and

(f) up to about 5 wt % of optional additives.

In accordance with the invention, glue sticks typically comprise, and if desired consist essentially of such adhesive compositions.

Objects and advantages of this invention are further illustrated by the following examples, but the particular materials and amounts thereof recited in these examples, as well as other conditions and details, should not be construed to unduly limit this invention. Unless otherwise indicated, all parts and percentages are by weight.

### EXAMPLES

The invention will be further understood with reference to the following examples and comparative examples.

Test Methods

The following test methods are used.

Adhesive Appearance Test:

The color of the stick is visually observed after the adhesive composition is formed into a glue stick according to the sample preparation methods described below. Compositions exhibiting a transparent or off-white color were rated “good”. Compositions exhibiting a brownish color were rated “poor”. Further, compositions that resulted in a deposit of brownish lumps or exhibited a brown color after setting were rated “poor”.

Adhesive Clumping Test:

When the adhesive is in the form of a glue stick it is desirable that the adhesive apply to a substrate in a smooth even layer. If the stick is not sufficiently firm, the adhesive fractures or breaks during application resulting in deposition of pieces of adhesive, i.e., “clumps” on the substrate rather than a smooth continuous adhesive film. This fracture and accompanying deposition of adhesive pieces during application is referred to as “clumping”.

Each adhesive was assigned a rating based on the amount of clumping occurring during application to paper. A common glue stick container with a rotary base was used to apply the adhesive with modest hand pressure. Prior to applying the adhesive, a razor blade was used to slice away the open end of the adhesive sample, leaving a flat adhesive surface. Samples which demonstrated an appreciable tendency to deposit fractured clumps of adhesive gel during use were rated “poor,” while samples which did not tend to deposit clumps were rated “good.”

Adhesive Transfer Test:

Adhesive compositions, in glue stick form, were applied on photocopy paper to test the ease/amount of adhesive transfer. A razor blade was used to slice away the open end of the sample, leaving a flat adhesive surface. A weight of 200 g is placed on the end of the stick opposite the flat adhesive surface, resulting in a constant or near constant amount of the pressure applied during the test. The weighted stick is moved across the surface of the photocopy paper, resulting in a single stoke of adhesive. If no adhesive or a small quantity of adhesive is transferred to the paper, the transfer is called “poor”. If the transferred stroke of adhesive is of consistent width and amount, the transfer is called “good”.

Adhesive Slip Test:

This test characterizes the ease of using adhesive composition in glue stick form. If the stick moves easily on the paper, the adhesive slip is identified as “good”. On the contrary, if the stick adheres to the paper, requiring the user to apply excess force to move the stick, the adhesive slip is identified as “poor”.

Adhesion Test:

This test provides a means of determining the adhesion of the composition after applying to a sheet of paper.

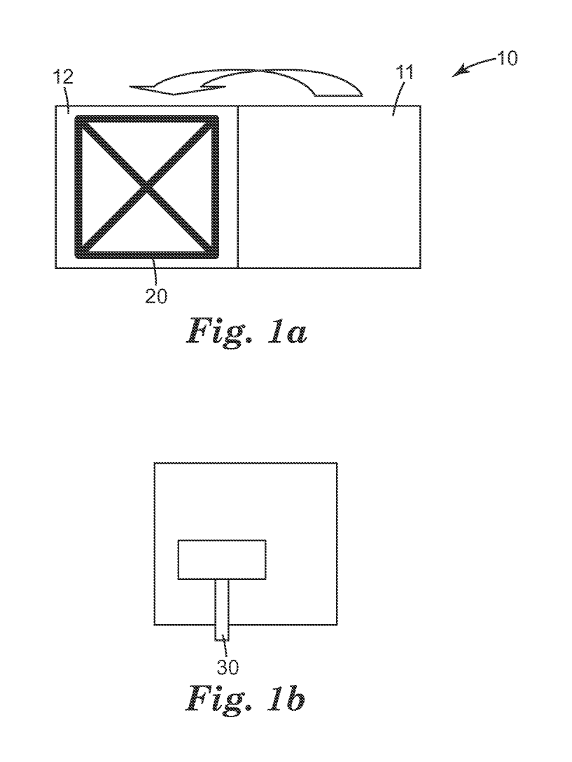

Aspects of the adhesion test are depicted in FIG. 1a. The adhesion test consists of folding a piece of photocopy paper 10 in two, applying a pattern 20 of adhesive on one half 12 of the photocopy paper 10, and bonding the two parts of the sheet, 11, 12 to one another. A 2 kg roller 30 is applied back and forth across the section of paper having the adhesive bond (See FIG. 1b). The test is done on at least 5 sheets. The adhered papers are dried at room temperature (23° C. and 50% relative humidity) for one hour. After the period of drying, the paper is observed for a delamination. If the sample paper delaminates, the adhesion is acceptable. The number of sheets in each set of 5 showing delamination is recorded.

Adhesive Setting Time:

This test provides a means of assessing the setting time of an adhesive, i.e., the period over which the adhesive remains tacky and or wet to the touch.

To perform this test, an adhesive is applied to a stroke of photocopy paper of 20 mm large and 250 mm long. The stroke is bonded to another sheet of photocopy paper and a 2 kg roller is applied back and forth across the section of paper having the adhesive bond. A stopwatch is triggered. Every 15 seconds, 20 to 40 mm of the stroke of paper is debonded and the paper is observed for delamination. If no delamination is observed, the test continues. If delamination is observed, the test is finished and the time is registered.

Hardness:

The hardness of each sample composition was measured in the general manner outlined in ASTM Test Method D-5, with dmm denoting penetration distance in tenths of millimeters.

Sample Preparation

Each of the illustrative examples was prepared in a 100 mL resin flask equipped with a stirring motor and heated bath. Samples were heated to temperatures of 70° to 90° C., preferably at 80° C. After a homogenous mixture was formed, bubbles were removed by applying aspirator vacuum for a period of 30 to 60 seconds and the resulting sample was poured into a container and allowed to cool before use. In each of the examples below, the mold used for cooling was a common glue stick container, having an inside diameter of approximately 16 mm, with a rotary base driving a screw type advancing mechanism. Comparative product samples were used as provided.

The formulations of each example and comparative example are as shown in Tables 1-3 wherein proportions are reported in wt %.

TABLE 1

| | Example | | | | | | |
|---|---|---|---|---|---|---|---|
| Component | 1 | 2 | 3 | 4 | 5 | 6 | 7 |
| Total water | 50.8 | 65.8 | 65.8 | 53.8 | 67.8 | 65.8 | 52.8 |
| TACKIDEX ® 036P | 0.0 | 20.0 | 0.0 | 0.0 | 0.0 | 0.0 | 0.0 |
| TACKIDEX ® 250 | 0.0 | 0.0 | 20.0 | 0.0 | 0.0 | 0.0 | 20.0 |
| TACKIDEX ® B039 | 0.0 | 0.0 | 0.0 | 0.0 | 0.0 | 20.0 | 0.0 |
| GLUCIDEX ® 1 | 35.0 | 0.0 | 0.0 | 35.0 | 20.0 | 0.0 | 0.0 |
| Sucrose | 0.0 | 0.0 | 0.0 | 0.0 | 0.0 | 0.0 | 15.0 |
| Sodium Stearate | 6.0 | 6.0 | 6.0 | 3.0 | 4.0 | 6.0 | 4.0 |
| Glycerol | 8.0 | 8.0 | 8.0 | 8.0 | 8.0 | 8.0 | 8.0 |
| Silcolapse ® RG12 | 0.1 | 0.1 | 0.1 | 0.1 | 0.1 | 0.1 | 0.1 |
| Preventor ® MP100 | 0.1 | 0.1 | 0.1 | 0.1 | 0.1 | 0.1 | 0.1 |

TABLE 2

| | Example | | | | | | |
|---|---|---|---|---|---|---|---|
| Component | 8 | 9 | 10 | 11 | 12 | 13 | 14 |
| Total water | 50.8 | 40.8 | 42.8 | 46.8 | 42.8 | 43.4 | 43.4 |
| TACKIDEX ® 250 | 20.0 | 20.0 | 20.0 | 20.0 | 20.0 | 18.5 | 18.5 |
| Sucrose | 15.0 | 25.0 | 25.0 | 20.0 | 24.0 | 25.0 | 25.0 |
| Sodium Stearate | 6.0 | 6.0 | 4.0 | 5.0 | 5.0 | 5.0 | 5.0 |
| Glycerol | 8.0 | 8.0 | 8.0 | 8.0 | 8.0 | 4.0 | 0.0 |
| Sorbitol | 0.0 | 0.0 | 0.0 | 0.0 | 0.0 | 4.0 | 8.0 |
| Silcolapse ® RG12 | 0.1 | 0.1 | 0.1 | 0.1 | 0.15 | 0.0 | 0.0 |
| Antifoam B | 0.0 | 0.0 | 0.0 | 0.0 | 0.0 | 0.05 | 0.05 |
| Preventor ® MP100 | 0.1 | 0.1 | 0.1 | 0.1 | 0.05 | 0.05 | 0.05 |

TABLE 3

Example

| Component | C1 | C2 |
|---|---|---|
| Total water | 54.5 | 46.3 |
| Pullulan | 22.0 | 15.0 |
| Sucrose | 5.0 | 5.0 |
| CaCl₂ | 0.0 | 2.0 |
| Kelcogel ® AFT | 0.0 | 1.5 |
| Sodium Stearate | 5.8 | 0.0 |
| Citric Acid | 0.0 | 0.01 |
| Glycerol | 12.5 | 15.0 |
| Silcolapse ® RG12 | 0.1 | 0.1 |
| Preventol ® MP100 | 0.1 | 0.1 |

TACKIDEX® 036P and TACKIDEX® 250 refer to natural, maize starches from Roquette America Inc., Keokuk, Iowa, USA.
TACKIDEX® B029 refers to a white dextrin from Roquette America Inc.
GLUCEDIX® 1 refers to a maltodextrine from Roquette America Inc.
Pullulan is a water soluble polysaccharide polymer from Aldrich Corporation, St. Louis, Mo., USA.
Sodium stearate from Viva Corporation, Mumbai, India.
Kelcogel® AFT refers to a hydrocolloid gellan gum available from CP Kelco, San Diego, Calif., USA.
Sucrose from Aldrich Corporation.
Glycerol from Aldrich Corporation.
Sorbitol from Aldrich Corporation.
Silcolapse® RG12 is a silicone emulsion based antifoaming agent from Blue Star SiliconesEast Brunswick, N.J., USA.
Antifoam B is a silicone emulsion based antifoaming agent from Dow Corning, Midland, Mich., USA.
Preventol® MP100 is a 3-iodo-2-propynyl butylcarbamate (IPBC) biocide from Lanxess Corp., Pittsburgh, Pa., USA.

Testing Results

Testing results of the Examples and comparative commercial adhesives are listed in Table 4 below.

TABLE 4

| | Properties | | | | | | | |
|---|---|---|---|---|---|---|---|---|
| | | | | | Setting | | | |
| Example | Clarity | Clumping | Transfer | Adhesion | Time | | Hardness | Slip |
| 1 | Good | Yes | NA | NA | NA | | NA | NA |
| 2 | Good | No | Poor | NA | NA | | NA | NA |
| 3 | Good | No | Medium | 1/5 | Not done | | 143 | Good |
| 4 | Good | Yes | NA | NA | NA | | NA | NA |
| 5 | Good | Yes | NA | NA | NA | | NA | NA |
| 6 | Poor | NA | NA | NA | NA | | NA | NA |
| 7 | Good | No | Medium | 5/5 | Not done | | 350 | Good |
| 8 | Good | No | Medium | 1/5 | Not done | | 204 | Good |
| 9 | Good | No | Medium | 5/5 | Not done | | 164 | Good |
| 10 | Good | No | Medium | 5/5 | Not done | | 224 | Good |
| 11 | Good | No | Medium | 5/5 | Not done | | 227 | Good |
| 12 | Good | No | Good | 5/5 | 4 | minutes | 190 | Good |
| 13 | Good | No | Good | 5/5 | 2 | minutes | 185 | Good |
| 14 | Poor | No | Good | 5/5 | 1 | minute | 190 | Good |
| | | | | | 30 | seconds | | |
| C1 | Poor | Yes | Good | 5/5 | 1 | min | 330 | Good |
| C2 | Good | Yes | Poor | 0/5 | Not done | | NA | Poor |
| Tesa ® | Good | No | Good | 5/5 | 30 | seconds | 155 | Good |
| ecoLogo ® | | | | | | | | |
| Glue Stick | | | | | | | | |
| Bic ™ | Good | No | Good | 4/5 | 2 | minutes | 183 | Good |
| Ecolutions ™ | | | | | | | | |
| Glue Stick | | | | | | | | |
| 3M Scotch ® | Good | No | Good | 5/5 | 45 | seconds | 140 | Good |
| Glue Stick | | | | | | | | |

3M Scotch ® Glue Stick is from 3M, St. Paul, MN.
Tesa ® ecoLogo ® glue stick is from Tesa SE, Hamburg, Germany
Bic ™ Ecolutions ™ glue stick is from BIC USA, Inc., Shelton, CT.

The complete disclosures of the patents, patent documents, and publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. An adhesive composition comprising at least one native starch; at least one gelling agent; sucrose; at least one humectant; and water.

2. The adhesive composition of claim 1 wherein the at least one native starch is selected from the group consisting of pea starch, maize starch, potato starch, amaranth starch, rice starch, wheat starch, barley starch (including waxy barley starch), manihot starch, sago starch, and combinations thereof.

3. The adhesive composition of claim 1 wherein the starch comprises maize starch.

4. The adhesive composition of claim 1 comprising from about 10 wt % to about 30 wt % of the at least one native starch.

5. The adhesive composition of claim 4 comprising from about 15 wt % to about 25 wt % of the at least one native starch.

6. The adhesive composition of claim 1 wherein the gelling agent comprises sodium stearate.

7. The adhesive composition of claim 1 comprising from about 0.5 wt % to about 10 wt % of gelling agent.

8. The adhesive composition of claim 1 wherein the humectant comprises at least one of glycerol and sorbitol.

9. The adhesive composition of claim 8 wherein the humectant comprises both glycerol and sorbitol.

10. The adhesive composition of claim 9 wherein the weight ratio of glycerol to sorbitol is at least 1:1 and no greater than 4:1.

11. The adhesive composition of claim 1 comprising from about 15 wt % to about 30 wt % sucrose.

12. The adhesive composition of claim 11 comprising from about 20 wt % to about 25 wt % sucrose.

13. An adhesive composition comprising:
(a) 10 to 30 wt % of at least one native starch;
(b) 15 to 30 wt % of sucrose;
(c) 5 to 15 wt % of at least one humectant;
(d) 0.5 to 10 wt % of at least one gelling agent; and
(e) 35 to 60 wt % of water.

14. The adhesive composition of claim 13 comprising:
(a) 15 to 25 wt % of at least one native starch;
(b) 20 to 25 wt % of sucrose;
(c) 5 to 15 wt % of at least one humectant;
(d) 3 to 8 wt % of at least one gelling agent; and
(e) 35 to 60 wt % of water.

15. The adhesive composition of claim 13 wherein the at least one native starch is selected from the group consisting of pea starch, maize starch, potato starch, amaranth starch, rice starch, wheat starch, barley starch (including waxy barley starch), manihot starch, sago starch, and combinations thereof.

16. The adhesive composition of claim 13 wherein, the at least one gelling agent comprises a sodium salt of a fatty acid.

17. The adhesive composition of claim 16 wherein the at least one gelling agent comprises sodium stearate.

18. The adhesive composition of claim 13 wherein the at least one humectant comprises a mixture of glycerol and sorbitol.

19. The adhesive composition of claim 13 comprising at least one additive selected from the group consisting of plasticizers, fillers, tackifiers, pigments, biocides, defoamers, surfactants, dyes, fragrances and preservatives.

20. An adhesive composition of claim 13 in the form of a glue stick.
